(19) United States
(12) Patent Application Publication
(10) Pub. No.: US 2021/0012790 A1
(43) Pub. Date: Jan. 14, 2021

(54) SIGNAL ANALYSIS DEVICE, SIGNAL ANALYSIS METHOD, AND SIGNAL ANALYSIS PROGRAM

(71) Applicant: NIPPON TELEGRAPH AND TELEPHONE CORPORATION, Tokyo (JP)

(72) Inventors: Nobutaka ITO, Musashino-shi, Tokyo (JP); Tomohiro NAKATANI, Musashino-shi, Tokyo (JP); Shoko ARAKI, Musashino-shi, Tokyo (JP)

(73) Assignee: NIPPON TELEGRAPH AND TELEPHONE CORPORATION, Tokyo (JP)

(21) Appl. No.: 16/981,294

(22) PCT Filed: Apr. 5, 2019
(86) PCT No.: PCT/JP2019/015215

§ 371 Date: Sep. 16, 2020

(30) Foreign Application Priority Data
Apr. 6, 2018 (JP) 2018-074239

(51) Int. Cl. G10L 21/0308; G10L 25/51; G10L 25/12

(52) U.S. Cl. CPC G10L 21/0308; G10L 25/12; G10L 25/51

(57) ABSTRACT

A signal analysis device (1) includes an estimation unit (10) that, when a parameter for modeling spatial characteristics of signals from N signal sources (where N is an integer equal to or larger than 2) is a spatial parameter, estimates a signal source position prior probability which is a mixture weight for modeling a prior distribution of the spatial parameter with respect to each signal source using a mixture distribution that is a linear combination of prior distributions of the spatial parameter with respect to K signal source position candidates (where K is an integer equal to or larger than 2), and which is a probability that a signal arrives from each signal source position candidate per signal source.

### TECHNICAL FIELD

The present invention relates to a signal analysis device, a signal analysis method, and a signal analysis program.

### BACKGROUND ART

There is a sound sauce separation technique that, in a situation where N′ sound source signals coexist (where N′ is an integer equal to or larger than 0), estimates each individual sound source signal from a plurality of observation signals that have been obtained by microphones at different positions. It is considered that N′ is the true number of sound sources, and N is the assumed number of sound sources. With the conventional technique, the assumed number of sound sources is set to be N=N′, assuming a situation where the true number of sound sources N′ is known.

### CITATION LIST

### Non Patent Literature

[NPL 1] T. Higuchi, N. Ito, S. Araki, T. Yoshioka, M. Delcroix, and T. Nakatani, “Online MVDR Beamformer Based on Complex Gaussian Mixture Model With Spatial Prior for Noise Robust ASR”, IEEE/ACM Transactions on Audio, Speech, and Language Processing (ASLP), vol. 25, no. 4, pp. 780-793, April 2017.

### SUMMARY OF THE INVENTION

### Technical Problem

A description is now given of a configuration and processing of a conventional sound source separation device using FIG. 6 and FIG. 7. FIG. 6 is a figure showing one example of a configuration of the conventional sound source separation device. FIG. 7 is a flowchart showing one example of a processing procedure of conventional sound source separation processing. Note that the notation “\hat{ }A” with respect to A which is a vector, a matrix, or a scalar is considered to be the same as “a sign represented by ‘\hat{ }A’ with ‘\hat{ }’ written immediately thereabove”. Also, the notation “˜A” with respect to A which is a vector, a matrix, or a scalar is considered to be the same as “a sign represented by ‘A’ with ‘˜’ written immediately thereabove”.

As shown in FIG. 6 and FIG. 7, a conventional signal analysis device 1P includes an observation signal vector generation unit 11P, an initializing unit (not shown), a sound source existence posterior probability updating unit 12P, a storage unit 13P, a sound source existence prior probability updating unit 14P, a spatial covariance matrix updating unit 15P, a power parameter updating unit 16P, a convergence determination unit (not shown), and a sound source signal component estimation unit 17P.

The observation signal vector generation unit 11P first obtains input observation signals yₘ(τ) (step S41), and calculates observation signals yₘ(t,f) in a time-frequency domain using, for example, short-time Fourier transform (step S42). Here, t=1, . . . , T denotes a frame index, f=1, . . . , F denotes a frequency bin index, m=1, . . . , M denotes a microphone index, and τ denotes a sample point index. It is considered that M microphones are placed at different positions.

Next, the observation signal vector generation unit 11P generates an observation signal vector y(t,f), which is an M-dimensional column vector composed of all of the obtained M observation signals yₘ(t,f), for each time-frequency point as in expression (1) (step S43). Here, a superscript T denotes a transpose.

[Formula 1]

y(t,f)=(y₁(t,f) . . . y_{M}(t,f))^{T} (1)

The initializing unit calculates initial values of estimated values of sound source existence prior probabilities αₙ(f), spatial covariance matrixes Rₙ(f), and power parameters vₙ(t,f) to initialize these parameters (step S44). Note that n=1, . . . , N denotes a sound source index. For example, the initializing unit calculates these initial values based on random numbers.

The sound source existence posterior probability updating unit 12P receives the observation signal vectors y(t,f) from the observation signal vector generation unit 11P, the sound source existence prior probabilities (note, as an exception, the initial values of the sound source existence prior probabilities from the initializing unit at the time of first processing in the sound source existence posterior probability updating unit 12P) αₙ(f) from the sound source existence prior probability updating unit 14P, the spatial covariance matrixes (note, as an exception, the initial values of the spatial covariance matrixes from the initializing unit at the time of first processing in the sound source existence posterior probability updating unit 12P) Rₙ(f) from the spatial covariance matrix updating unit 15P, and the power parameters (note, as an exception, the initial values of the power parameters from the initializing unit at the time of first processing in the sound source existence posterior probability updating unit 12P) vₙ(t,f) from the power parameter updating unit, and updates sound source existence posterior probabilities λₙ(t,f) (step S45).

The storage unit 13P stores parameters of prior distributions of the spatial covariance matrixes for respective sound source signals n and respective frequency bins f.

The sound source existence prior probability updating unit 14P receives the sound source existence posterior probabilities λₙ(t,f) from the sound source existence posterior probability updating unit 12P, and updates the sound source existence prior probabilities αₙ(f) (step S46).

The spatial covariance matrix updating unit 15P receives the observation signal vectors y(t,f) from the observation signal vector generation unit 11P, the sound source existence posterior probabilities λₙ(t,f) from the sound source existence posterior probability updating unit 12P, the parameters of the prior distributions from the storage unit 13P, and the power parameters (note, as an exception, the initial values of the power parameters from the initializing unit at the time of first processing in the spatial covariance matrix updating unit 15P) vₙ(t,f) from the power parameter updating unit 16P, and updates the spatial covariance matrixes Rₙ(f) (step S47).

The power parameter updating unit 16P receives the observation signal vectors y(t,f) from the observation signal vector generation unit 11P and the spatial covariance matrixes Rₙ(f) from the spatial covariance matrix updating unit 15P, and updates the power parameters vₙ(t,f) (step S48).

The convergence determination unit determines whether convergence has been achieved (step S49). If the convergence determination unit has determined that convergence has not been achieved (step S49: No), processing is continued with a return to processing in the sound source existence posterior probability updating unit 12P (step S45). On the other hand, if the convergence determination unit has determined that convergence has been achieved (step S49: Yes), processing in the sound source signal component estimation unit 17P follows.

The sound source signal component estimation unit 17P receives the observation signal vectors y(t,f) from the observation signal vector generation unit 11P and the sound source existence posterior probabilities λₙ(t,f) from the sound source existence posterior probability updating unit 12P, and calculates and outputs estimated values \hat{ }xₙ(t,f) of sound source signal components xₙ(t,f) (step S50).

A description is now given of the features of the conventional technique. The observation signal vectors y(t,f) generated by the observation signal vector generation unit 11P are expressed by expression (2) as a sum of sound source signal components x₁(t,f), . . . , x_{N}(t,f) that are components derived from N sound source signals.

$$[ Formula 2 ]$$

$$y ( t , f ) = {\sum }_{n = 1}^{N} {x}_{n} ( t , f ) \qquad ( 2 )$$

With the conventional technique, it is assumed that each sound source signal has a property where significant energy is held only at sparse points in a time-frequency domain (sparse property). For example, it is considered that speech satisfies this sparse property relatively well. Under this assumption, at each time-frequency point, the observation signal vector y(t,f) can be approximated to be composed of only one of the N sound source signal components x₁(t,f), . . . , x_{N}(t,f) (expression (3)).

[Formula 3]

y(t,f)≅x_{n(t,f)}(t,f) (3)

Here, n(t,f) is an index of a sound source signal existing at a time-frequency point (t,f), and takes a value of an integer equal to or larger than 1 and equal to or smaller than N.

Under the model of expression (3), sound separation can be realized as long as estimated values \hat{ }n(t,f) of indexes n(t,f) of sound source signals existing at respective time-frequency points (t,f) can be obtained. That is to say, once \hat{ }n(t,f) can be obtained, the estimated value \hat{ }xₙ(t,f) of the n^{th} sound source signal component xₙ(t,f) can be obtained, that is to say, sound separation can be realized, by blocking or attenuating the energy of sound other than the time-frequency point at which the n^{th} sound source signal exists as in the following expression (4).

$$[ Formula 4 ]$$

$${\hat{x}}_{n} ( t , f ) = \{ \begin{matrix}y ( t , f ) , & if \hat{n} ( t , f ) = n \\ 0 , & otherwise \end{matrix} \qquad ( 4 )$$

With the conventional technique, estimation of n(t,f) is realized by modeling the probability distributions of the observation signal vectors y(t,f) using a complex Gaussian mixture distribution of the following expression (5), and applying this model to the observation signal vectors y(t,f).

$$[ Formula 5 ]$$

$$p ( y ( t , f ) \vert Θ ) = {\sum }_{n = 1}^{N} {α}_{n} ( f ) {p}_{G} ( y ( t , f ) ; 0 , {v}_{n} ( t , f ) {R}_{n} ( f ) ) \qquad ( 5 )$$

Here, p_{G} denotes a Gaussian mixture distribution (where G is the initial of Gauss). Rₙ(f) denotes a spatial covariance matrix which is a parameter indicating the spatial characteristics (acoustic transmission characteristics) of each sound source, and vₙ(t,f) denotes a power parameter which is a parameter for modeling a power spectrum of each sound source. αₙ(f) denotes a mixture weight that satisfies expression (6), and is also referred to as a sound source existence prior probability in the present specification.

$$[ Formula 6 ]$$

$${\sum }_{n = 1}^{N} {α}_{n} ( f ) = 1 \qquad ( 6 )$$

Also, Θ collectively denotes all unknown parameters, and is specifically composed of the sound source existence prior probabilities αₙ(f), the spatial covariance matrixes Rₙ(f), and the power parameters vₙ(t,f). Once the parameters Θ can be estimated, given the observation signal vectors y(t,f), the posterior probabilities of the sound source indexes n(t,f) can be obtained using the following expression (7).

$$[ Formula 7 ]$$

$${λ}_{n} ( t , f ) = \frac{{α}_{n} ( f ) {p}_{G} ( y ( t , f ) ; 0 , {v}_{n} ( t , f ) {R}_{n} ( f ) )}{{\sum }_{v = 1}^{N} {α}_{v} ( f ) {p}_{G} ( y ( t , f ) ; 0 , {v}_{v} ( t , f ) {R}_{v} ( f ) )} \qquad ( 7 )$$

Using this, the sound source indexes n(t,f) can be estimated as in the following expression (8).

$$[ Formula 8 ]$$

$$\hat{n} ( t , f ) = arg {max}_{n} {λ}_{n} ( t , f ) \qquad ( 8 )$$

With use of these estimated values of the sound source indexes, sound source separation can be realized in accordance with expression (4).

Accurate estimation of the parameters Θ is the key to realizing high-precision sound source separation based on this approach. In general, the longer the length of the given observation signals, the easier the accurate estimation of the parameters Θ, whereas the shorter the length of the given observation signals, the more difficult the accurate estimation of the parameters Θ. In view of this, to prevent degradation of the estimation precision of the parameters Θ in the case where the length of the given observation signals is short, it is important to appropriately set prior distributions that represent prior knowledge related to the parameters Θ. By appropriately setting prior distributions, the parameters Θ can be estimated with a certain level of accuracy based on the prior knowledge related to the parameters Θ, even when the length of the given observation signals is short, thus making it possible to prevent a significant reduction in the estimation precision of the parameters Θ. Furthermore, prior distributions are important also to prevent degradation of the estimation precision of parameters immediately after sound source signals started to produce sound in online processing, and to avoid a permutation problem.

A description is now given of the permutation problem. An observation signal vector y(t,f) conforms to a distribution that varies with each frequency bin. Therefore, with a sound source separation approach based on estimation (clustering) of sound source indexes n(t,f) using the mixture model as in expression (5), in general, it is possible to perform classification (clustering) of sound sources exclusively within each frequency bin, but correspondence between sound sources of different frequencies cannot be obtained. This is called the permutation problem.

With the conventional technique, prior distributions p(Rₙ(f)) of spatial covariance matrixes Rₙ(f), which are parameters for modeling the spatial characteristics of respective sound source signals, are designed under the assumption that the sound source positions of respective sound sources are known. Specifically, with the conventional technique, the prior distributions p(Rₙ(f)) of the spatial covariance matrixes Rₙ(f) are modeled using the inverse Wishart distribution of the following expression (9).

[Formula 9]

p(Rₙ(f)=IW(Rₙ(f);\tilde{Ψ}ₙ(f),\tilde{ν}ₙ(f)) (9)

Here, IW denotes the inverse Wishart distribution (“IW” is an acronym of “Inverse Wishart”). ˜Ψₙ(f) denotes a scale matrix for modeling the position of a peak (mode) of a prior distribution p(Rₙ(f)), and ˜νₙ(f) denotes a degree of freedom for modeling the dispersion of a peak of a prior distribution p(Rₙ(f)). Hereinafter, it is assumed that the degree of freedom ˜νₙ(f) is constant regardless of the sound source and the frequency bin, and is simply written as ˜ν. The scale matrix ˜Ψₙ(f) and the degree of freedom ˜ν, which are parameters of a prior distribution p(Rₙ(f)), are parameters for modeling a parameter Rₙ(f), and are referred to as hyper parameters in that sense.

Based on expression (9), the prior distributions p(Rₙ(1), . . . , Rₙ(F)) of the spatial covariance matrixes Rₙ(1), . . . , Rₙ(F) in all frequency bins are as indicated by the following expression (10).

$$[ Formula 10 ]$$

$$p ( {R}_{n} ( 1 ) , … , {R}_{n} ( F ) ) = {\prod }_{f = 1}^{F} ℐ𝒲 ( {R}_{n} ( f ) ; {\tilde{Ψ}}_{n} ( f ) , {\tilde{v}}_{n} ( f ) ) \qquad ( 10 )$$

Here, independence between frequencies is assumed.

With the conventional technique, under the assumption that the sound source positions of respective sound sources are known, it is assumed that the scale matrix ˜Ψₙ(f) and the degree of freedom ˜ν, which are hyper parameters of a prior distribution p(Rₙ(f)), are known. These hyper parameters can be learnt in advance based on learning data. That is to say, when the sound source positions of respective sound sources are known, an observation signal of a case where a sound source signal arrives from a known sound source position is actually measured per sound source, and this is used as learning data; in this way, the scale matrix ˜Ψₙ(f) and the degree of freedom ˜ν, which are hyper parameters of a prior distribution p(Rₙ(f)), can be learnt in advance.

With the conventional technique, based on this prior distribution, the parameters θ are estimated by alternatingly and repeatedly applying the update rules indicated by the following expression (11) to expression (14).

$$\begin{matrix}[ Formula 11 ] & \\ {λ}_{n} ( t , f ) ← \frac{{α}_{N} ( f ) {p}_{G} ( y ( t , f ) ; 0 , {v}_{n} ( t , f ) {R}_{n} ( f ) )}{{\sum }_{v = 1}^{N} {α}_{v} ( f ) {p}_{G} ( y ( t , f ) ; 0 , {v}_{v} ( t , f ) {R}_{v} ( f ) )} & ( 11 ) \\ [ Formula 12 ] & \\ {α}_{n} ( f ) ← \frac{1}{T} {\sum }_{t = 1}^{T} {λ}_{n} ( t , f ) & ( 12 ) \\ [ Formula 13 ] & \\ {R}_{n} ( f ) ← \frac{{\sum }_{t = 1}^{T} {λ}_{n} ( t , f ) \frac{1}{{v}_{n} ( t , f )} y ( t , f ) {y ( t , f )}^{H} + \frac{1}{2} {\tilde{Ψ}}_{n} ( f )}{{\sum }_{t = 1}^{T} {λ}_{n} ( t , f ) + \frac{\tilde{v} + M + 1}{2}} & ( 13 ) \\ [ Formula 14 ] & \\ {v}_{n} ( t , f ) ← \frac{1}{M} {y ( t , f )}^{H} {{R}_{n} ( f )}^{- 1} y ( t , f ) & ( 14 )\end{matrix}$$

The process of expression (11) is performed in the sound source existence posterior probability updating unit 12P, the process of expression (12) is performed in the sound source existence prior probability updating unit 14P, the process of expression (13) is performed in the spatial covariance matrix updating unit 15P, and the process of expression (14) is performed in the power parameter updating unit 16P. The sound source signal component estimation unit 17P calculates the estimated values \hat{ }n(t,f) of the sound source indexes using expression (8) based on the sound source existence posterior probabilities λₙ(t,f) from the sound source existence posterior probability updating unit 12P, which have been obtained through the foregoing processes, and further calculates the estimated values \hat{ }xₙ(t,f) of the sound source signal components using expression (4).

However, with the conventional technique, it is assumed that the sound source positions of respective sound source signals are known, and application is not possible when the sound source positions of respective sound source signals are unknown.

With the foregoing in view, it is an object of the present invention to provide a signal analysis device, a signal analysis method, and a signal analysis program that can perform signal analysis, such as signal source separation, based on a prior distribution of a spatial parameter (e.g., a spatial covariance matrix), which is a parameter for modeling the spatial characteristics of respective sound source signals, even when the sound source positions of respective sound source signals are unknown.

### Means for Solving the Problem

To solve the aforementioned problem and achieve the object, a signal analysis device of the present invention is characterized by including an estimation unit that, when a parameter for modeling spatial characteristics of signals from N signal sources (where N is an integer equal to or larger than 2) is a spatial parameter, estimates a signal source position prior probability which is a mixture weight for modeling a prior distribution of the spatial parameter with respect to each signal source using a mixture distribution that is a linear combination of prior distributions of the spatial parameter with respect to K signal source position candidates (where K is an integer equal to or larger than 2), and which is a probability that a signal arrives from each signal source position candidate per signal source.

### Effects of the Invention

According to the present invention, signal analysis, such as sound source separation, can be performed based on a prior distribution of a spatial parameter, even when the sound source positions of respective sound source signals are unknown.

### BRIEF DESCRIPTION OF DRAWINGS

FIG. 1 is a figure showing one example of a configuration of a signal analysis device according to a first embodiment.

FIG. 2 is a flowchart showing one example of a processing procedure of signal analysis processing according to the first embodiment.

FIG. 3 is a figure showing one example of a configuration of a signal analysis device according to a fourth modification example of the first embodiment.

FIG. 4 is a flowchart showing one example of a processing procedure of signal analysis processing according to the fourth modification example of the first embodiment.

FIG. 5 is a figure showing one example of a computer with which a signal analysis device is realized through the execution of a program.

FIG. 6 is a figure showing one example of a configuration of a conventional sound source separation device.

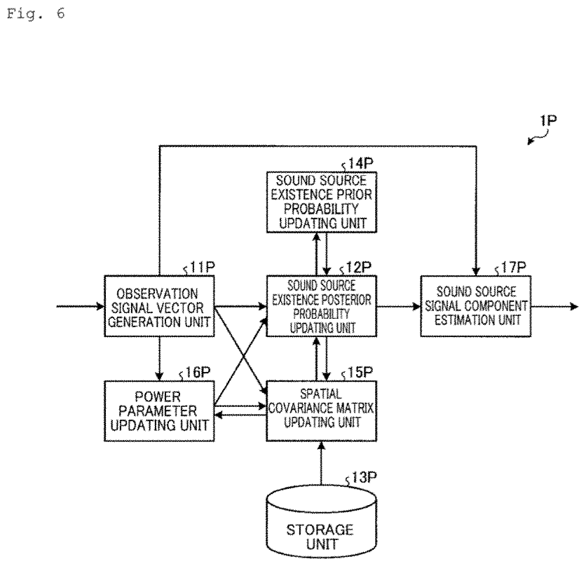

FIG. 7 is a flowchart showing one example of a processing procedure of conventional sound source separation processing.

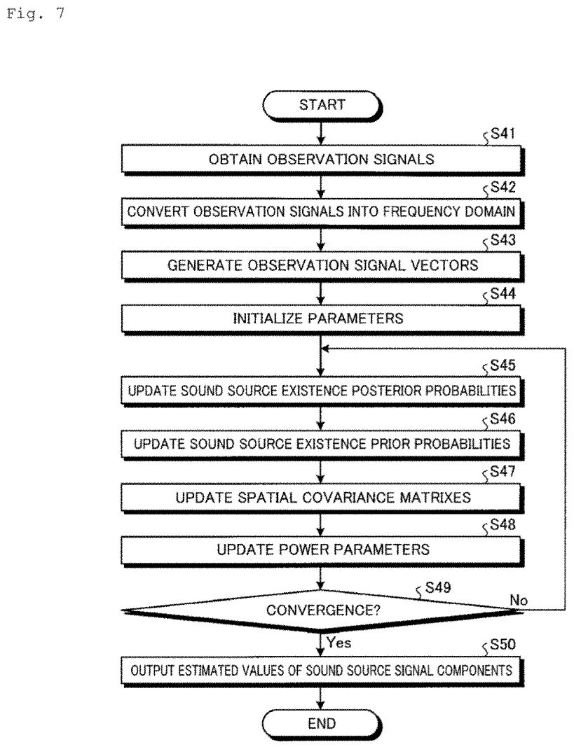

### DESCRIPTION OF EMBODIMENTS

Below, an embodiment of a signal analysis device, a signal analysis method, and a signal analysis program according to the present application will be described in detail based on the figures. Also, the present invention is not limited by the embodiment described below. Note that hereinafter, the notation “\hat{ }A” with respect to A which is a vector, a matrix, or a scalar is considered to be the same as “a sign represented by ‘A’ with ‘\hat{ }’ written immediately thereabove”. Also, the notation “˜A” with respect to A which is a vector, a matrix, or a scalar is considered to be the same as “a sign represented by ‘A’ with ‘˜’ written immediately thereabove”.

### First Embodiment

First, a signal analysis device according to a first embodiment will be described. Note that in the first embodiment, it is considered that in a situation where N′ sound source signals coexist (where N′ is an integer equal to or larger than 0), M observation signals yₘ(τ) (m=1, . . . , M denotes a microphone index, and τ denotes a sample point index) that have been obtained by microphones at different positions are input to the signal analysis device (where M is an integer equal to or larger than 2). It is considered that N′ is the true number of sound sources, and N is the assumed number of sound sources. In the first embodiment, the assumed number of sound sources is set to be N=N′, assuming a situation where the true number of sound sources N′ is known. Note that a “sound source signal” in the present first embodiment may be a target signal (e.g., speech), or may be directional noise (e.g., music played on a TV), which is noise arriving from a specific sound source position. Also, diffusive noise, which is noise arriving from various sound source positions, may be collectively regarded as one “sound source signal”. Examples of diffusive noise include speaking voices of many people in crowds, a café, and the like, sound of footsteps in a station or an airport, and noise attributed to air conditioning.

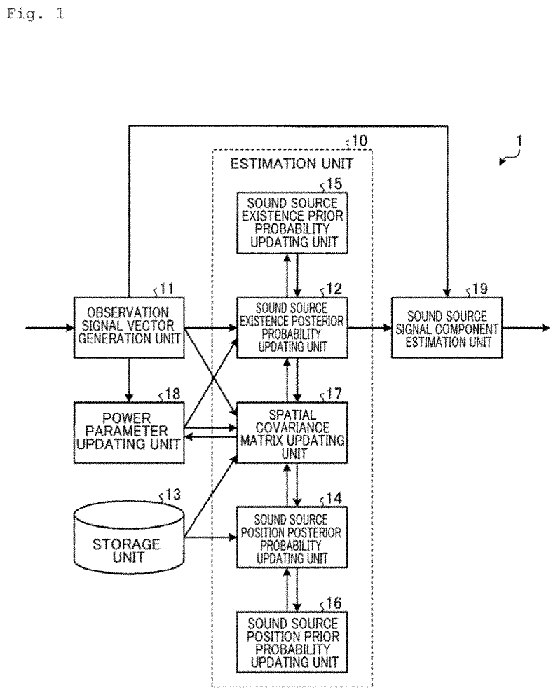

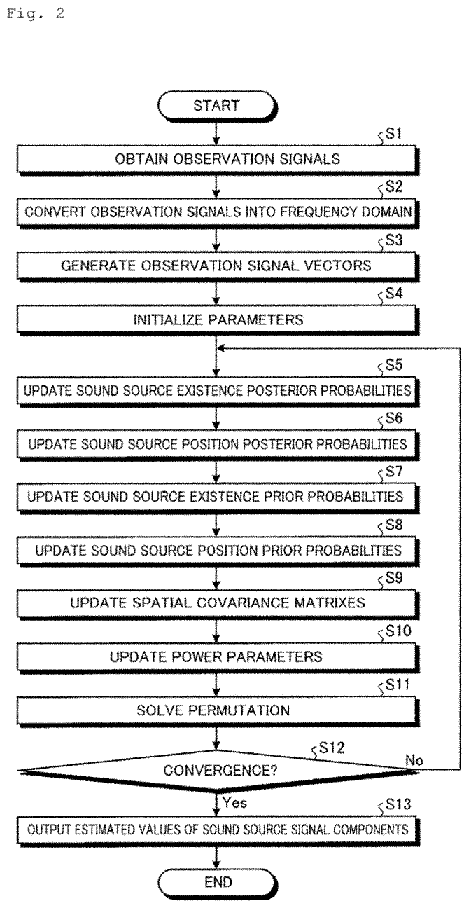

A configuration and processing of the first embodiment will be described using FIG. 1 and FIG. 2. FIG. 1 is a figure showing one example of a configuration of the signal analysis device according to the first embodiment. FIG. 2 is a flowchart showing one example of a processing procedure of signal analysis processing according to the first embodiment. A signal analysis device 1 according to the first embodiment is realized as, for example, a predetermined program is read into a computer and the like including a ROM (Read Only Memory), a RAM (Random Access Memory), a CPU (Central Processing Unit), and the like, and the CPU executes the predetermined program.

As shown in FIG. 1, the signal analysis device 1 includes an observation signal vector generation unit 11, an initializing unit (not shown), an estimation unit 10, a storage unit 13, a power parameter updating unit 18, a permutation solving unit (not shown), a convergence determination unit (not shown), and a sound source signal component estimation unit 19.

First, an overview of respective units of the signal analysis device 1 will be described. The observation signal vector generation unit 11 first obtains input observation signals yₘ(τ) (step S1), and calculates observation signals yₘ(t,f) in a time-frequency domain using, for example, short-time Fourier transform (step S2). Here, t=1, . . . , τ denotes a frame index, and f=1, . . . , F denotes a frequency bin index.

Next, the observation signal vector generation unit 11 generates an observation signal vector y(t,f), which is an M-dimensional column vector composed of all of the obtained M observation signals yₘ(t,f), that is to say, an observation signal vector y(t,f) indicated by expression (15), for each time-frequency point (step S3). Here, a superscript τ denotes a transpose.

[Formula 15]

y(t,f)=(y₁(t,f) . . . y_{M}(t,f))^{T} (15)

In the present first embodiment, it is assumed that each sound source signal arrives from one of K sound source position candidates, and these sound source position candidates are represented by indexes (hereinafter, “sound source position indexes”) 1, . . . , K. For example, in a case where sound sources are a plurality of speakers who are having a conversation while being seated around a round table, M microphones are placed within a small area of approximately several square centimeters at the center of the round table, and only the azimuths of sound sources viewed from the center of the round table are focused as sound source positions, K azimuths Δϕ, 2Δϕ, . . . , KΔϕ (Δϕ=360°/K) obtained by equally dividing 0° to 360° into K can be used as the sound source position candidates. No limitation is intended by this example; in general, arbitrary predetermined K points can be designated as the sound source position candidates. Also, the sound source position candidates may be sound source position candidates indicating diffusive noise. Diffusive noise does not arrive from one sound source position, but arrives from many sound source positions. By regarding such diffusive noise, too, as one sound source position candidate “arriving from many sound source positions”, accurate estimation can be made even in a situation where diffusive noise exists.

The initializing unit calculates initial values of estimated values of sound source existence prior probabilities αₙ(f), sound source position prior probabilities βₖₙ, spatial covariance matrixes Rₙ(f), and power parameters vₙ(t,f) (step S4). Note that n=1, . . . , N denotes a sound source index, and k=1, . . . , K denotes a sound source position index. For example, the initializing unit calculates these initial values based on random numbers.

The estimation unit 10 estimates sound source position prior probabilities. In the present first embodiment, spatial covariance matrixes are used as spatial parameters which are parameters for modeling the spatial characteristics of signals from the positions of N sound sources. A sound source position prior probability is a probability that a signal arrives from each sound source position candidate per sound source, and is a mixture weight for modeling a prior distribution of a spatial covariance matrix (a spatial parameter) with respect to each sound source. The foregoing prior distribution with respect to each sound source is modeled using a mixture distribution which is a linear combination of prior distributions of a spatial covariance matrix (a spatial parameter) with respect to K sound source position candidates (where K is an integer equal to or larger than 2). The estimation unit 10 includes a sound source existence posterior probability updating unit 12, a sound source position posterior probability updating unit 14, a sound source existence prior probability updating unit 15, a sound source position prior probability updating unit 16, and a spatial covariance matrix updating unit 17.

The sound source existence posterior probability updating unit 12 receives the observation signal vectors y(t,f), the sound source existence prior probabilities αₙ(f), the spatial covariance matrixes Rₙ(f), and the power parameters vₙ(t,f), and updates the sound source existence posterior probabilities λₙ(t,f) (step S5).
The observation signal vectors y(t,f) are the output from the observation signal vector generation unit 11.
The sound source existence prior probabilities αₙ(f) are the output from the sound source existence prior probability updating unit 15. Note, as an exception, these are the initial values of the sound source existence prior probabilities from the initializing unit at the time of first processing in the sound source existence posterior probability updating unit 12.
The spatial covariance matrixes Rₙ(f) are the output from the spatial covariance matrix updating unit 17. Note, as an exception, these are the initial values of the spatial covariance matrixes from the initializing unit at the time of first processing in the sound source existence posterior probability updating unit 12.
The power parameters vₙ(t,f) are the output from the power parameter updating unit 18. Note, as an exception, these are the initial values of the power parameters from the initializing unit at the time of first processing in the sound source existence posterior probability updating unit 12.

The storage unit 13 stores parameters of prior distributions of the spatial covariance matrixes for respective sound source position candidates k and respective frequency bins f.

The sound source position posterior probability updating unit 14 receives the parameters of the prior distributions, the sound source position prior probabilities βₖₙ, and the spatial covariance matrixes Rₙ(f), and updates sound source position posterior probabilities μₖₙ.
The parameters of the prior distributions are stored in the storage unit 13 (step S6).
The sound source position prior probabilities βₖₙ are the output from the sound source position prior probability updating unit 16. Note, as an exception, these are the initial values of the sound source position prior probabilities from the initializing unit at the time of first processing in the sound source position posterior probability updating unit 14.
The spatial covariance matrixes Rₙ(f) are the output from the spatial covariance matrix updating unit 17. Note, as an exception, these are the initial values of the spatial covariance matrixes from the initializing unit at the time of first processing in the sound source position posterior probability updating unit 14.

The sound source existence prior probability updating unit 15 receives the sound source existence posterior probabilities λₙ(t,f) from the sound source existence posterior probability updating unit 12, and updates the sound source existence prior probabilities αₙ(f) (step S7).

The sound source position prior probability updating unit 16 receives the sound source position posterior probabilities μₖₙ from the sound source position posterior probability updating unit 14, and updates the sound source position prior probabilities βₖₙ (step S8).

The spatial covariance matrix updating unit 17 receives the observation signal vectors y(t,f), the sound source existence posterior probabilities λₙ(t,f), the parameters of the prior distributions, the sound source position posterior probabilities μₖₙ, and the power parameters vₙ(t,f), and updates the spatial covariance matrixes Rₙ(f) (step S9).
The observation signal vectors y(t,f) are the output from the observation signal vector generation unit 11.
The sound source existence posterior probabilities λₙ(t,f) are the output from the sound source existence posterior probability updating unit 12.
The parameters of the prior distributions are stored in the storage unit 13.
The sound source position posterior probabilities μₖₙ are the output from the sound source position posterior probability updating unit 14.
The power parameters vₙ(t,f) are the output from the power parameter updating unit 18. Note, as an exception, these are the initial values of the power parameters from the initializing unit at the time of first processing in the spatial covariance matrix updating unit 17.

The power parameter updating unit 18 receives the observation signal vectors y(t,f) from the observation signal vector generation unit 11 and the spatial covariance matrixes Rₙ(f) from the spatial covariance matrix updating unit 17, and updates the power parameters vₙ(t,f) (step S10).

The permutation solving unit receives the sound source existence prior probabilities αₙ(f) from the sound source existence prior probability updating unit 15, the spatial covariance matrixes Rₙ(f) from the spatial covariance matrix updating unit 17, and the power parameters vₙ(t,f) from the power parameter updating unit 18, and solves the permutation problem by updating the sound source existence prior probabilities αₙ(f), the spatial covariance matrixes Rₙ(f), and the power parameters vₙ(t,f) (step S1). Specifically, the permutation solving unit updates these parameters by switching the sound source index n for each frequency bin so that an evaluation value of, for example, a likelihood, a log-likelihood, or an auxiliary function is maximized. That is to say, when switching of the sound source index n for a frequency bin f is represented by a bijective function σ_{f}:{1, . . . , N}→{1, . . . , N}, the bijective function σ_{f} is calculated so that an evaluation value of, for example, a likelihood, a log-likelihood, or an auxiliary function is maximized when the sound source index n of these parameters has been switched to σ_{f}(n) for each frequency bin f. These parameters are updated by, with use of the calculated bijective function σ_{f}, switching the sound source index n of these parameters to σ_{f}(n) for each frequency bin f. Note that instead of updating all of the sound source existence prior probabilities αₙ(f), the spatial covariance matrixes Rₙ(f), and the power parameters vₙ(t,f), the permutation solving unit may update only a part thereof (e.g., only the spatial covariance matrixes Rₙ(f)). Note that processing in the permutation solving unit is not indispensable.

Subsequently, the convergence determination unit determines whether convergence has been achieved (step S12). If the convergence determination unit has determined that convergence has not been achieved (step S12: No), subsequent processing is continued with a return to processing in the sound source existence posterior probability updating unit 12 (step S5). On the other hand, if the convergence determination unit has determined that convergence has been achieved (step S12: Yes), processing in the sound source signal component estimation unit 19 (step S13) follows.

The sound source signal component estimation unit 19 receives the observation signal vectors y(t,f) from the observation signal vector generation unit 11 and the sound source existence posterior probabilities λₙ(t,f) from the sound source existence posterior probability updating unit 12, and calculates and outputs estimated values \hat{ }xₙ(t,f) of sound source signal components xₙ(t,f) (step S13).

Next, the features of the first embodiment will be described in comparison to the conventional technique. As described earlier, with the conventional technique, the prior distributions p(Rₙ(1), . . . , Rₙ(F)) of the spatial covariance matrixes Rₙ(1), . . . , Rₙ(F) in all frequency bins are modeled using the following expression (16) (relisting of expression (10)).

$$[ Formula 16 ]$$

$$p ( {R}_{n} ( 1 ) , … , {R}_{n} ( F ) ) = {\prod }_{f = 1}^{F} ℐ𝒲 ( {R}_{n} ( f ) ; {\tilde{Ψ}}_{n} ( f ) , {\tilde{v}}_{n} ( f ) ) \qquad ( 16 )$$

However, the problem with the conventional technique is that, with the assumption that the sound source positions of respective sound sources are known, application is not possible when the sound source positions of respective sound sources are unknown.

In contrast, according to the present first embodiment, the prior distributions p (Rₙ(1), . . . , Rₙ(F)) of the spatial covariance matrixes Rₙ(1), . . . , Rₙ(F) in all frequency bins are modeled using a complex inverse Wishart mixture distribution of the following expression (17).

$$[ Formula 17 ]$$

$$p ( {R}_{n} ( 1 ) , … , {R}_{n} ( F ) \vert {β}_{1 n} , … , {β}_{Kn} ) = {\sum }_{k = 1}^{K} \underbrace{{β}_{kn}}_{{{Probability that sound source}_{n is at sound source position}}_{candidate k }} \times \underbrace{{\prod }_{f = 1}^{F} {ℐ𝒲}_{C} ( {R}_{n} ( f ) ; {Ψ}_{k} ( f ) , {v}_{k} ( f ) )}_{{{Prior distribution with respect}_{to sound source position }}_{candidate k }} \qquad ( 17 )$$

This is represented as an average of prior distributions with respect to a sound source position candidate k, using the probability βₖₙ that a sound source n is at the sound source position candidate k as a weight. As it is assumed that the sound source positions of respective sound sources are unknown in the present first embodiment, βₖₙ is an unknown probability. However, as βₖₙ is a probability, it is considered that βₖₙ satisfies the following expression (18).

$$[ Formula 18 ]$$

$${\sum }_{k = 1}^{K} {β}_{kn} = 1 \qquad ( 18 )$$

In this way, based on a weighted sum using an unknown probability βₖₙ, the prior distributions of the spatial covariance matrixes can be designed even when the sound source positions of respective sound sources are unknown. Although βₖₙ is unknown, this, too, can be regarded as an unknown parameter and estimated simultaneously with other unknown parameters.

In the present first embodiment, it is considered that parameters Ψₖ(f) and νₖ(f) of the complex inverse Wishart distribution for respective sound source position candidates k and respective frequency bins f are prepared and stored into the storage unit 13 in advance. These parameters may be prepared in advance based on information of microphone arrangement, or may be learnt in advance from data that has been actually measured.

For example, when these parameters are prepared in advance based on information of microphone arrangement, it is sufficient to calculate a steering vector of a plane wave corresponding to each sound source position candidate k from expression (19), with Cartesian coordinates of each microphone m regarded as rₘ, and to calculate Ψₖ(f) and νₖ(f) from the following expression (20) and expression (21).

$$\begin{matrix}[ Formula 19 ] & \\ {h}_{k} ( f ) = \frac{1}{\sqrt{M}} {( exp ( j {ω}_{f} \frac{{d}_{k}^{T} {r}_{1}}{c} ) … exp ( j {ω}_{f} \frac{{d}_{k}^{T} {r}_{M}}{c} ) )}^{T} & ( 19 ) \\ [ Formula 20 ] & \\ {Ψ}_{k} ( f ) = ( {v}_{k} ( f ) - M ) {h}_{k} ( f ) {{h}_{k} ( f )}^{H} & ( 20 ) \\ [ Formula 21 ] & \\ {v}_{k} ( f ) = M + 1.1 & ( 21 )\end{matrix}$$

Here, dₖ denotes a unit vector indicating an arrival direction of a sound source signal corresponding to the k^{th} sound source position candidate, c denotes a sound speed, ω_{f} denotes an angular frequency corresponding to a frequency bin f, j indicated by expression (21-1) denotes an imaginary unit, and a superscript H denotes a Hermitian transpose.

[Formula 22]

j [symbol] \sqrt{−1} (21-1)

A description is now given of derivation of prior distributions (expression (17)) according to the present first embodiment. It is assumed that the sound source positions of respective sound sources are unknown, and it is assumed that a sound source position index kn corresponding to the sound source position of each sound source n conforms to an unknown probability distribution indicated by expression (22). βₖₙ denotes a sound source position prior probability, which is a probability distribution of a sound source position index per sound source.

[Formula 23]

P(kₙ=k|β₁ₙ, . . . ,β_{Kn})=βₖₙ (22)

Furthermore, in the present first embodiment, on the condition that a sound source position index for a sound source n is kₙ=k, it is considered that spatial covariance matrixes Rₙ(1), . . . , Rₙ(F) of the sound source n conform to the probability distribution (expression (23)) independently of each other.

[Formula 24]

p(Rₙ(f)|kₙ=k)=I [symbol] (Rₙ(f);Ψₖ(f),νₖ(f)) (23)

Here, Ψₖ(f) denotes a parameter (scale matrix) indicating the positions of peaks (modes) of prior distributions of spatial covariance matrixes for respective sound source position candidates, and νₖ(f) denotes a parameter indicating the dispersions (degrees of freedom) of peaks of prior distributions of spatial covariance matrixes for respective sound source position candidates. Also, IW_{C}(Σ;Ψ,ν), which is indicated by expression (24), is the complex inverse Wishart distribution with a scale matrix Ψ and a degree of freedom ν.

$$[ Formula 25 ]$$

$${ℐ𝒲}_{ℂ} ( Σ ; Ψ , v ) = \frac{{( det Ψ )}^{v}}{{π}^{M ( M - 1 ) \text{/} 2} {\prod }_{m = 1}^{M} Γ ( v - m + 1 )} \frac{exp ( - tr ( {ΨΣ}^{- 1} ) )}{{( det Σ )}^{v + M}} \qquad ( 24 )$$

Under the modeling of expression (22) and expression (23), the probability distributions of the spatial covariance matrixes Rₙ(1), . . . , Rₙ(F) of the sound source n are given by the following expression (25) to expression (28).

$$\begin{matrix} [ Formula 26 ] & \\ p ( {R}_{n} ( 1 ) , … , {R}_{n} ( F ) \vert {β}_{1 n} , … , {β}_{Kn} ) = {\sum }_{k = 1}^{K} p ( {R}_{n} ( 1 ) , … , {R}_{n} ( F ) , {k}_{n} = k \vert {β}_{1 n} , … , {β}_{Kn} ) ( ∵ Rule of sum ) & ( 25 ) \\ = {\sum }_{k = 1}^{K} P ( {k}_{n} = k \vert {β}_{1 n} , … , {β}_{Kn} ) p ( {R}_{n} ( 1 ) , ⋯ , {R}_{n} ( F ) \vert {k}_{n} = k ) ( ∵ Rule of product ) & ( 26 ) \\ = {\sum }_{k = 1}^{K} P ( {k}_{n} = k \vert {β}_{1 n} , … , {β}_{Kn} ) {\prod }_{f = 1}^{F} p ( {R}_{n} ( f ) \vert {k}_{n} = k ) ( ∵ Independence ) & ( 27 ) \\ = {\sum }_{k = 1}^{K} {β}_{kn} {\prod }_{j = 1}^{F} {ℐ𝒲}_{ℂ} ( {R}_{n} ( f ) ; {Ψ}_{k} ( f ) {v}_{k} ( f ) ) ( ∵ ( 22 ) , ( 23 ) ) & ( 28 )\end{matrix}$$

In the present embodiment, parameters are estimated based on prior distributions (expression (17)). Below, parameter estimation algorithms of the present embodiment will be described. Note that hereinafter, for simplicity, the complex inverse Wishart distribution “IW_{C}” is simply referred to as “IW” with the omission of the attached letter C. Assuming that prior distributions of unknown parameters other than the spatial covariance matrixes Rₙ(f) are uniform distributions, prior distributions of parameters Θ are given by the following expression (29) and expression (30).

$$[ Formula 27 ]$$

$$\begin{matrix}p ( Θ ) ∝ {\prod }_{n = 1}^{N} p ( {R}_{n} ( 1 ) , … , {R}_{n} ( F ) \vert {β}_{1 n} , … , {β}_{Kn} ) & ( 29 ) \\ = {\prod }_{n = 1}^{N} {\sum }_{k = 1}^{K} {β}_{kn} {\prod }_{f = 1}^{F} ℐ𝒲 ( {R}_{n} ( f ) ; {Ψ}_{k} ( f ) , {v}_{k} ( f ) ) ( ∵ ( 17 ) ) & ( 30 )\end{matrix}$$

Note that the parameters Θ according to the present first embodiment are composed of the sound source existence prior probabilities αₙ(f), the power parameters vₙ(t,f), the spatial covariance matrixes Rₙ(f), and the sound source position prior probabilities βₖₙ.

On the other hand, given the parameters Θ, assuming that the observation signal vectors y(t,f) at respective time-frequency points are independent of each other, a likelihood is given by the following expression (31) and expression (32).

$$[ Formula 28 ]$$

$$\begin{matrix}p ( y \vert Θ ) = {\prod }_{t = 1}^{T} {\prod }_{f = 1}^{F} p ( y ( t , f ) \vert Θ ) ( ∵ Independence ) & ( 31 ) \\ = {\prod }_{t = 1}^{T} {\prod }_{f = 1}^{F} {\sum }_{n = 1}^{N} {α}_{n} ( f ) {p}_{G} ( y ( t , f ) ; 0 , {v}_{n} ( t , f ) {R}_{n} ( f ) ) ( ∵ ( 5 ) ) & ( 32 )\end{matrix}$$

Here, Y collectively denotes the observation signal vectors y(t,f) at all time-frequency points.

In the present first embodiment, the parameters Θ are estimated by maximizing the posterior probabilities p(Θ|Y) of the parameters Θ. Based on Bayes's theorem, these posterior probabilities can be expressed by expression (33), and removing logarithms from both sides results in expression (34).

$$\begin{matrix}[ Formula 29 ] & \\ p ( Θ \vert y ) = \frac{p ( y \vert Θ ) p ( Θ )}{p ( y )} & ( 33 ) \\ [ Formula 30 ] & \\ ln p ( Θ \vert y ) = ln p ( y \vert Θ ) + ln p ( Θ ) - ln p ( y ) & ( 34 )\end{matrix}$$

As ln p(Y) is not dependent on the parameters Θ, the maximization regarding Θ of the posterior probabilities p(Θ|Y) is equivalent to the maximization regarding Θ of the following expression (35), and is thus equivalent to the maximization regarding Θ of an objective function J (Θ) indicated by the following expression (36).

$$[ Formula 31 ]$$

$$\begin{matrix} ln p ( y \vert Θ ) + ln p ( Θ ) & ( 35 ) \\ {=}^{c} {\sum }_{t = 1}^{T} {\sum }_{f = 1}^{F} ln {\sum }_{n = 1}^{N} {α}_{n} ( f ) {p}_{G} ( y ( t , f ) ; 0 , {v}_{n} ( t , f ) {R}_{n} ( f ) ) + {\sum }_{n = 1}^{N} ln {\sum }_{k = 1}^{K} {β}_{kn} {\prod }_{f = 1}^{F} ℐ𝒲 ( {R}_{n} ( f ) ; {Ψ}_{k} ( f ) , {v}_{k} ( f ) ) ( \text{=:} J ( Θ ) ) ( ∵ ( 32 ) , ( 30 ) ) & ( 36 )\end{matrix}$$

Here, a sign represented by = with “c” written immediately thereabove is a sign indicating that both sides are equal, excluding a difference between constants that are not dependent on the parameters Θ. Also, “A=:B” means defining B with A.

The maximization of the objective function J (Θ) in the foregoing expression can be performed based on an auxiliary function method. With the auxiliary function method, the following two steps are iterated alternatingly based on an auxiliary function Q(Θ,Φ), which is a function of the parameters Θ and a variable Φ called an auxiliary variable.

1. A step of updating the auxiliary variable Φ by maximizing the auxiliary function Q(Θ,Φ) with respect to the auxiliary variable Φ.
2. A step of updating the parameters Θ without causing a reduction in the auxiliary function Q(Θ,Φ).

Note, it is considered that the auxiliary function Q(Θ,Φ) satisfies the condition indicated by the following expression (37).

$$[ Formula 32 ]$$

$${max}_{Φ} Q ( Θ , Φ ) = J ( Θ ) \qquad ( 37 )$$

With respect to arbitrary Θ,

With this auxiliary function method, the objective function J(Θ) can be monotonically increased. That is to say, provided that the estimated values of the parameters Θ obtained as a result of the i^{th} iteration is Θ(ⁱ), expression (38) holds.

[Formula 33]

J(Θ⁽ⁱ⁾≤J(Θ⁽ⁱ⁺¹⁾) (38)

In practice, provided that the value of the auxiliary variable Φ obtained as a result of the i^{th} iteration is 0(i), expression (39) and expression (40) hold based on expression (37).

[Formula 34]

j(Θ⁽ⁱ⁾)=Q(Θ⁽ⁱ⁾,Φ⁽ⁱ⁺¹⁾) (39)

J(Θ⁽ⁱ⁺¹⁾)=Q(Θ⁽ⁱ⁺¹⁾,Φ⁽ⁱ⁺²⁾) (40)

Therefore, the following expression (41) holds, and hence expression (38) is obtained.

[Formula 35]

Q(Θ⁽ⁱ⁾,Φ⁽ⁱ⁺¹⁾)≤Q(Θ⁽ⁱ⁺¹⁾,Φ⁽ⁱ⁺¹⁾)≤Q(Θ⁽ⁱ⁺¹⁾,Φ⁽ⁱ⁺²⁾) (41)

With the auxiliary function method, it is necessary to design an auxiliary function Q(Θ,Φ) that satisfies expression (37). To this end, Jensen's inequality is used in the present first embodiment. It is known that, provided that f is a convex function, w₁, . . . , w_{L} are non-negative numbers that satisfy expression (42), and x₁, . . . , x_{L} are real numbers, expression (43) holds (the condition of satisfaction of equality is x₁= . . . =x_{L}).

$$\begin{matrix}[ Formula 36 ] & \\ {\sum }_{l = 1}^{L} {w}_{l} = 1 & ( 42 ) \\ [ Formula 37 ] & \\ f ( {\sum }_{l = 1}^{L} {w}_{l} {x}_{l} ) \leq {\sum }_{l = 1}^{L} {w}_{l} f ( {x}_{l} ) & ( 43 )\end{matrix}$$

This is called Jensen's inequality. Especially, provided that f(x)=−ln x, expression (44) is obtained.

$$[ Formula 38 ]$$

$$ln {\sum }_{l = 1}^{L} {w}_{l} {x}_{l} \geq {\sum }_{l = 1}^{L} {w}_{l} ln {x}_{l} \qquad ( 44 )$$

Provided that λ₁(t,f), . . . , λ_{N}(t,f) are non-negative numbers that satisfy expression (45), expression (46) and expression (47) are obtained from expression (44).

$$\begin{matrix} [ Formula 39 ] & \\ {\sum }_{n = 1}^{N} {λ}_{n} ( t , f ) = 1 & ( 45 ) \\ [ Formula 40 ] & \\ ln {\sum }_{n = 1}^{N} {α}_{n} ( f ) {p}_{G} ( y ( t , f ) ; 0 , {v}_{n} ( t , f ) {R}_{n} ( f ) ) = ln {\sum }_{n = 1}^{N} {λ}_{n} ( t , f ) \frac{{α}_{n} ( f ) {p}_{G} ( y ( t , f ) ; 0 , {v}_{n} ( t , f ) {R}_{n} ( f ) )}{{λ}_{n} ( t , f )} & ( 46 ) \\ \geq {\sum }_{n = 1}^{N} {λ}_{n} ( t , f ) ln \frac{{α}_{n} ( f ) {p}_{G} ( y ( t , f ) ; 0 , {v}_{n} ( t , f ) {R}_{n} ( f ) )}{{λ}_{n} ( t , f )} & ( 47 )\end{matrix}$$

Furthermore, provided that μ₁ₙ, . . . , μ_{Kn} are non-negative numbers that satisfy expression (48), expression (49) and expression (50) are obtained from expression (44).

$$\begin{matrix} [ Formula 41 ] & \\ {\sum }_{k = 1}^{K} {μ}_{kn} = 1 & ( 48 ) \\ [ Formula 42 ] & \\ ln {\sum }_{k = 1}^{K} {β}_{kn} {\prod }_{f = 1}^{F} ℐ𝒲 ( {R}_{n} ( f ) ; {Ψ}_{k} ( f ) , {v}_{k} ( f ) ) = ln {\sum }_{k = 1}^{K} {μ}_{kn} \frac{{β}_{kn} {\prod }_{f = 1}^{F} ℐ𝒲 ( {R}_{n} ( f ) ; {Ψ}_{k} ( f ) , {v}_{k} ( f ) )}{{μ}_{kn}} & ( 49 ) \\ \geq {\sum }_{k = 1}^{K} {μ}_{kn} ln \frac{{β}_{kn} {\prod }_{f = 1}^{F} ℐ𝒲 ( {R}_{n} ( f ) ; {Ψ}_{k} ( f ) , {v}_{k} ( f ) )}{{μ}_{kn}} & ( 50 )\end{matrix}$$

Expression (51) is obtained from expression (47) and expression (50).

$$[ Formula 43 ]$$

$${\sum }_{t = 1}^{T} {\sum }_{f = 1}^{F} ln {\sum }_{n = 1}^{N} {α}_{n} ( f ) {p}_{G} ( y ( t , f ) ; 0 , {v}_{n} ( t , f ) {R}_{n} ( f ) ) + {\sum }_{n = 1}^{N} ln {\sum }_{k = 1}^{K} {β}_{kn} {\prod }_{f = 1}^{F} ℐ𝒲 ( {R}_{n} ( f ) ; {Ψ}_{k} ( f ) , {v}_{k} ( f ) ) \geq {\sum }_{t = 1}^{T} {\sum }_{f = 1}^{F} {\sum }_{n = 1}^{N} {λ}_{n} ( t , f ) ln \frac{{α}_{n} ( f ) {p}_{G} ( y ( t , f ) ; 0 , {v}_{n} ( t , f ) {R}_{n} ( f ) )}{{λ}_{n} ( t , f )} + {\sum }_{n = 1}^{N} {\sum }_{k = 1}^{K} {μ}_{kn} ln \frac{{β}_{kn} {\prod }_{f = 1}^{F} ℐ𝒲 ( {R}_{n} ( f ) ; {Ψ}_{k} ( f ) , {v}_{k} ( f ) )}{{μ}_{kn}} \qquad ( 51 )$$

Therefore, when the right-hand side of expression (51) is replaced with expression (52), expression (53) holds from expression (36) and expression (51).

$$[ Formula 44 ]$$

$$Q ( Θ , Φ ) = {\sum }_{t = 1}^{T} {\sum }_{f = 1}^{F} {\sum }_{n = 1}^{N} {λ}_{n} ( t , f ) ln \frac{{α}_{n} ( f ) {p}_{G} ( y ( t , f ) ; 0 , {v}_{n} ( t , f ) {R}_{n} ( f ) )}{{λ}_{n} ( t , f )} + {\sum }_{n = 1}^{N} {\sum }_{k = 1}^{K} {μ}_{kn} ln \frac{{β}_{kn} {\prod }_{f = 1}^{F} ℐ𝒲 ( {R}_{n} ( f ) ; {Ψ}_{k} ( f ) , {v}_{k} ( f ) )}{{μ}_{kn}} \qquad ( 52 )$$

[Formula 45]

With respect to arbitrary Θ and Φ, Q(Θ,Φ)≥J(Θ) (53)

Note, it is considered that the auxiliary variable Φ is composed of Δₙ(t,f) and μₖₙ.

The condition of satisfaction of equality of expression (51) is expression (54) and expression (55).

$$\begin{matrix} [ Formula 46 ] & \\ \frac{{α}_{1} ( f ) {p}_{G} ( y ( t , f ) ; 0 , {v}_{1} ( t , f ) {R}_{1} ( f ) )}{{λ}_{1} ( t , f )} = ⋯ = \frac{{α}_{N} ( f ) {p}_{G} ( y ( t , f ) ; 0 , {v}_{N} ( t , f ) {R}_{N} ( f ) )}{{λ}_{N} ( t , f )} & ( 54 ) \\ \frac{{β}_{1 n} {\prod }_{f = 1}^{F} ℐ𝒲 ( {R}_{n} ( f ) ; {Ψ}_{1} ( f ) , {v}_{1} ( f ) )}{{μ}_{1 n}} = ⋯ = \frac{{β}_{Kn} {\prod }_{f = 1}^{F} ℐ𝒲 ( {R}_{n} ( f ) ; {Ψ}_{K} ( f ) , {v}_{K} ( f ) )}{{μ}_{Kn}} & ( 55 )\end{matrix}$$

This is equivalent to the following expression (56) and expression (57).

$$\begin{matrix}[ Formula 47 ] & \\ {λ}_{n} ( t , f ) = \frac{{α}_{n} ( f ) {p}_{G} ( y ( t , f ) ; 0 , {v}_{n} ( t , f ) {R}_{n} ( f ) )}{{\sum }_{v = 1}^{N} {α}_{v} ( f ) {p}_{G} ( y ( t , f ) ; 0 , {v}_{v} ( t , f ) {R}_{v} ( f ) )} & ( 56 ) \\ {μ}_{kn} = \frac{{β}_{kn} {\prod }_{f = 1}^{F} ℐ𝒲 ( {R}_{n} ( f ) ; {Ψ}_{k} ( f ) , {v}_{k} ( f ) )}{{\sum }_{κ = 1}^{K} {β}_{kn} {\prod }_{f = 1}^{F} ℐ𝒲 ( {R}_{n} ( f ) ; {Ψ}_{κ} ( f ) , {v}_{κ} ( f ) )} & ( 57 )\end{matrix}$$

Therefore, expression (58) holds.

[Formula 48]

With respect to arbitrary Θ, Φ exists, and Q(Θ,Φ)=J(Θ) (58)

It is apparent that, from expression (53) and expression (58), Q(Θ,Φ) of expression (52) satisfies expression (37). In the foregoing manner, the auxiliary function with respect to the objective function J(Θ) has been designed.

In the present first embodiment, the auxiliary variable Φ and the parameters Θ are updated as follows based on the auxiliary function Q(Θ,Φ) of expression (52). First, it is sufficient to update the auxiliary variable Φ using expression (56) and expression (57). Also, it is sufficient to update the parameters Θ using the following expression (59) to expression (62).

$$\begin{matrix}[ Formula 49 ] & \\ {α}_{n} ( f ) ← \frac{1}{T} {\sum }_{t = 1}^{T} {λ}_{n} ( t , f ) & ( 59 ) \\ [ Formula 50 ] & \\ {β}_{kn} ← {μ}_{kn} & ( 60 ) \\ [ Formula 51 ] & \\ {R}_{n} ( f ) ← \frac{{\sum }_{t = 1}^{T} {λ}_{n} ( t , f ) \frac{1}{{v}_{n} ( t , f )} y ( t , f ) {y ( t , f )}^{H} + {\sum }_{k = 1}^{K} {μ}_{kn} {Ψ}_{k} ( f )}{{\sum }_{t = 1}^{T} {λ}_{n} ( t , f ) + {\sum }_{k = 1}^{K} {μ}_{kn} {v}_{k} ( f ) + M} & ( 61 ) \\ [ Formula 52 ] & \\ {v}_{n} ( t , f ) ← \frac{1}{M} {y ( t , f )}^{H} {{R}_{n} ( f )}^{- 1} y ( t , f ) & ( 62 )\end{matrix}$$

In this way, in the present first embodiment, instead of directly maximizing the objective function of expression (36), the objective function of expression (36) is indirectly maximized by alternatingly iterating the step of updating (by maximizing the auxiliary function Q(Θ,Φ) with respect to the auxiliary variable Φ, and the step of updating the parameters Θ without causing a reduction in the auxiliary function Q(Θ,Φ), based on the auxiliary function Q(Θ,Φ). Regarding the objective function of expression (36), a sum Σₖ₌₁^{K} related to k is included in the logarithm ln, and differentiation of the objective function of expression (36) with respect to each parameter is complicated; thus, directly maximizing the objective function of expression (36) using, for example, a gradient method makes the update rules complicated. In contrast, regarding the auxiliary function Q(Θ,Φ), the sum Σₖ₌₁^{K} related to k is outside the logarithm ln, and differentiation of the auxiliary function Q(Θ,Φ) with respect to each parameter is simple. Also, although the gradient method requires an adjustment of a step size that sets a parameter update amount per iteration, the auxiliary function method does not require the adjustment of the step size as the step size is unnecessary.

λₙ(t,f) that has been updated using expression (56) is nothing other than a sound source existence probability “after” the observation signal vectors y(t,f) have been observed. In practice, based on Bayes's theorem, expression (56) can also be written as expression (63).

$$[ Formula 53 ]$$

$$\begin{matrix}{λ}_{n} ( t , f ) = \frac{P ( n ( t , f ) = n \vert Θ ) p ( y ( t , f ) \vert n ( t , f ) = n , Θ )}{{\sum }_{v = 1}^{N} P ( n ( t , f ) = v \vert Θ ) p ( y ( t , f ) \vert n ( t , f ) = v , Θ )} \\ = P ( n ( t , f ) = n \vert y ( t , f ) , Θ )\end{matrix} \qquad ( 63 )$$

In view of this, λₙ(t,f) is referred to as a sound source existence posterior probability. In contrast, αₙ(f) (expression (64)) is a sound source existence probability “before” the observation signal vectors y(t,f) are observed, and is thus referred to as a sound source existence prior probability.

[Formula 54]

αₙ(f)=P(n(t,f)=n|Θ) (64)

Furthermore, μₖₙ that has been updated using expression (57) is nothing other than a sound source position probability “after” the spatial covariance matrixes Rₙ(1), . . . , Rₙ(F) have been given. In practice, (57) can also be written as expression (65).

$$[ Formula 55 ]$$

$$\begin{matrix}{μ}_{kn} = \frac{P ( {k}_{n} = k \vert {β}_{1 n} , … {β}_{Kn} ) p ( {R}_{n} ( 1 ) , … , {R}_{n} ( F ) \vert {k}_{n} = k )}{{\sum }_{κ = 1}^{K} P ( {k}_{n} = κ \vert {β}_{1 n} , … {β}_{Kn} ) p ( {R}_{n} ( 1 ) , … , {R}_{n} ( F ) \vert {k}_{n} = κ )} \\ = P ( {k}_{n} = k \vert {R}_{n} ( 1 ) , … , {R}_{n} ( F ) , {β}_{1 n} , … {β}_{Kn} )\end{matrix} \qquad ( 65 )$$

In view of this, μₖₙ is referred to as a sound source position posterior probability. In contrast, βₖₙ (expression (66)) is a sound source position probability “before” the spatial covariance matrixes Rₙ(1), . . . , Rₙ(F) are given, and is thus referred to as a sound source position prior probability.

[Formula 56]

βₖₙ=P(kₙ=k|β₁ₙ, . . . ,β_{Kn}) (66)

The process of expression (56) is performed in the sound source existence posterior probability updating unit 12, the process of expression (57) is performed in the sound source position posterior probability updating unit 14, the process of expression (59) is performed in the sound source existence prior probability updating unit 15, the process of expression (60) is performed in the sound source position prior probability updating unit 16, the process of expression (61) is performed in the spatial covariance matrix updating unit 17, and the process of expression (62) is performed in the power parameter updating unit 18.

A description is now given of derivation of the aforementioned expression (59) to expression (62) representing the update rules of the parameters Θ. First, the auxiliary function of expression (52) can be calculated as in the following expression (67) and expression (68). Here, C is a constant that is not dependent on the parameters Θ.

$$\begin{matrix} [ Formula 57 ] & \\ Q ( Θ , Φ ) = {\sum }_{t = 1}^{T} {\sum }_{f = 1}^{F} {\sum }_{n = 1}^{N} {λ}_{n} ( t , f ) [ ln {α}_{n} ( f ) - M ln {υ}_{n} ( t , f ) - ln det {R}_{n} ( f ) - \frac{1}{{υ}_{n} ( t , f )} {y ( t , f )}^{H} {{R}_{n} ( f )}^{- 1} y ( i , f ) ] + {\sum }_{n = 1}^{N} {\sum }_{k = 1}^{K} {μ}_{kn} [ ln {β}_{kn} - {\sum }_{f = 1}^{F} tr ( {Ψ}_{k} ( f ) {{R}_{n} ( f )}^{- 1} ) - {\sum }_{f = 1}^{F} ( {v}_{k} ( f ) + M ) ln det {R}_{n} ( f ) ] + C & ( 67 ) \\ = {\sum }_{f = 1}^{F} {\sum }_{n = 1}^{N} ( {\sum }_{t = 1}^{T} {λ}_{n} ( t , f ) ) ln {α}_{n} ( f ) - M {\sum }_{t = 1}^{T} {\sum }_{f = 1}^{F} {\sum }_{n = 1}^{N} {λ}_{n} ( t , f ) ln {υ}_{n} ( t , f ) - {\sum }_{f = 1}^{F} {\sum }_{n = 1}^{N} ( {\sum }_{t = 1}^{T} {λ}_{n} ( t , f ) ) ln det {R}_{n} ( f ) - {\sum }_{t = 1}^{T} {\sum }_{f = 1}^{F} {\sum }_{n = 1}^{N} {λ}_{n} ( t , f ) \frac{1}{{υ}_{n} ( t , f )} {y ( t , f )}^{H} {{R}_{n} ( f )}^{- 1} y ( t , f ) + {\sum }_{n = 1}^{N} {\sum }_{k = 1}^{K} {μ}_{kn} ln {β}_{kn} - {\sum }_{n = 1}^{N} {\sum }_{f = 1}^{F} tr [ ( {\sum }_{k = 1}^{K} {μ}_{kn} {Ψ}_{k} ( f ) ) {{R}_{n} ( f )}^{- 1} ] - {\sum }_{n = 1}^{N} {\sum }_{f = 1}^{F} ( {\sum }_{k = 1}^{K} {μ}_{kn} {v}_{k} ( f ) + M ) ln det {R}_{n} ( f ) + C & ( 68 )\end{matrix}$$

To derive expression (59) representing the update rule of the sound source existence prior probabilities αₙ(f), given 0 as the result of differentiating expression (69) using αₙ(f), with serving as a Lagrange undetermined multiplier and with attention to the constraint condition of expression (6), expression (70) is yielded.

$$\begin{matrix}[ Formula 58 ] & \\ {\sum }_{n = 1}^{N} ( {\sum }_{t = 1}^{T} {λ}_{n} ( t , f ) ) ln {α}_{n} ( f ) - ξ ( {\sum }_{n = 1}^{N} {α}_{n} ( f ) - 1 ) & ( 69 ) \\ [ Formula 59 ] & \\ ( {\sum }_{t = 1}^{T} {λ}_{n} ( t , f ) ) \frac{1}{{α}_{n} ( f )} - ξ = 0 & ( 70 )\end{matrix}$$

Solving expression (70) with respect to αₙ(f) yields expression (71).

$$\begin{matrix}[ Formula 60 ] & \\ {α}_{n} ( f ) = \frac{1}{ξ} {\sum }_{t = 1}^{T} {λ}_{n} ( t , f ) & ( 71 )\end{matrix}$$

Assigning expression (71) to expression (6) representing the constraint condition, to determine the value of the Lagrange undetermined multiplier (included in expression (71), yields expressions (72) to (74).

$$\begin{matrix}[ Formula 61 ] & \\ 1 = {\sum }_{n = 1}^{N} \frac{1}{ξ} {\sum }_{t = 1}^{T} {λ}_{n} ( t , f ) & ( 72 ) \\ = \frac{1}{ξ} {\sum }_{t = 1}^{T} {\sum }_{n = 1}^{N} {λ}_{n} ( t , f ) & ( 73 ) \\ = \frac{T}{ξ} ( ∵ ( 45 ) ) & ( 74 )\end{matrix}$$

Therefore, ξ=T, and thus expression (59) representing the update rule of the sound source existence prior probabilities αₙ(f) is obtained. As expression (60) representing the update rule of the sound source position prior probabilities βₖₙ can be derived in a similar manner, a description thereof is omitted.

To derive expression (61) representing the update rule of the spatial covariance matrixes Rₙ(f), given 0 as the result of differentiating expression (68) using Rₙ(f), expression (75) is yielded.

$$\begin{matrix} [ Formula 62 ] & \\ - ( {\sum }_{t = 1}^{T} {λ}_{n} ( t , f ) ) {{R}_{n} ( f )}^{- 1} + {{R}_{n} ( f )}^{- 1} ( {\sum }_{i = 1}^{T} {λ}_{n} ( t , f ) ) \frac{1}{{υ}_{n} ( t , f )} y ( t , f ) {y ( t , f )}^{H} {{R}_{n} ( f )}^{- 1} + {{R}_{n} ( f )}^{- 1} ( {\sum }_{k = 1}^{K} {μ}_{kn} {Ψ}_{k} ( f ) ) {{R}_{n} ( f )}^{- 1} - ( {\sum }_{k = 1}^{K} {μ}_{kn} {v}_{n} ( f ) + M ) {{R}_{n} ( f )}^{- 1} = 0 & ( 75 )\end{matrix}$$

Multiplying both sides of the foregoing expression by Rₙ(f), from left and right, yields expression (76). By solving this with respect to Rₙ(f), expression (61) representing the update rule of the spatial covariance matrixes Rₙ(f) is obtained.

$$\begin{matrix} [ Formula 63 ] & \\ - ( {\sum }_{t = 1}^{T} {λ}_{n} ( t , f ) ) {R}_{n} ( f ) + {\sum }_{t = 1}^{T} {λ}_{n} ( t , f ) \frac{1}{{υ}_{n} ( t , f )} y ( t , f ) {y ( t , f )}^{H} + {\sum }_{k = 1}^{K} {μ}_{kn} {Ψ}_{k} ( f ) - ( {\sum }_{k = 1}^{K} {μ}_{kn} {v}_{k} ( f ) + M ) {R}_{n} ( f ) = 0 & ( 76 )\end{matrix}$$

To derive expression (62) representing the update rule of the power parameters vₙ(t,f), given 0 as the result of differentiating expression (68) using vₙ(t,f), expression (77) is yielded.

$$\begin{matrix} [ Formula 64 ] & \\ - M {λ}_{n} ( t , f ) \frac{1}{{υ}_{n} ( t , f )} + {λ}_{n} ( t , f ) {y ( t , f )}^{H} {{R}_{n} ( f )}^{- 1} y ( t , f ) \frac{1}{{{υ}_{n} ( t , f )}^{2}} = 0 & ( 77 )\end{matrix}$$

By solving this with respect to vₙ(t,f), expression (62) representing the update rule of the power parameters vₙ(t,f) is obtained. Expressions (59) to (62) representing the update rules of the aforementioned parameters Θ have been derived in the foregoing manner.

The present first embodiment is based on modeling in which the prior distributions of the spatial covariance matrixes Rₙ(f), which are parameters of the complex Gaussian distribution, are prior distributions based on the complex inverse Wishart distribution. By thus using the complex Gaussian distribution and the complex inverse Wishart distribution in combination, an auxiliary function Q(Θ,Φ) is formatted such that an expression that gives 0 as the result of differentiation thereof with respect to the spatial covariance matrixes Rₙ(f) can be solved with respect to Rₙ(f) (described above). This is because the complex inverse Wishart distribution is a conjugate prior distribution of the complex Gaussian distribution. Regarding the conjugate prior distribution, see Reference Literature 2, “C. M. Bishop, ‘Pattern Recognition and Machine Learning’, Springer, 2006.”

### Effects of First Embodiment

As described above, in the present first embodiment, a signal source position prior probability is estimated. The signal source position prior probability is a mixture weight for modeling a prior distribution of a spatial covariance matrix with respect to each signal source using a mixture distribution which is a linear combination of prior distributions of spatial covariance matrixes with respect to a plurality of signal source position candidates. Also, the signal source position prior probability is the probability that a signal arrives from each signal source position candidate per signal source. Specifically, in the present first embodiment, a prior distribution of a spatial covariance matrix with respect to each signal source is modeled as in expression (17). Also, in the present first embodiment, based on a weighted sum using a sound source position prior probability βₖₙ, which is an unknown probability, prior distributions of spatial covariance matrixes can be designed even when the sound source positions of respective sound sources are unknown. Therefore, in the present first embodiment, even when the sound source positions with respect to respective sound source signals are unknown, signal source separation can be performed based on prior distributions of spatial covariance matrixes.

Furthermore, in the present first embodiment, due to the use of an auxiliary function in which a sum related to k is not included in the logarithm ln as indicated by expression (52), differentiation of the auxiliary function with respect to each parameter is simple, and parameter update computation is not complicated.

Moreover, the present first embodiment is based on modeling in which prior distributions of spatial covariance matrixes are prior distributions based on the complex inverse Wishart distribution. In the present first embodiment, by thus using the complex Gaussian distribution and the complex inverse Wishart distribution in combination, an auxiliary function Q(Θ, Φ) is such that an expression that gives 0 as the result of differentiation thereof with respect to the spatial covariance matrixes Rₙ(f) can be solved with respect to Rₙ(f).

### First Modification Example of First Embodiment

Although observation signal vectors y(t,f) are used as observation data in the present first embodiment, other feature vectors or feature amounts may be used as observation data. For example, feature vectors z(t,f) that are defined by expression (78) and expression (79) based on the observation signal vectors y(t,f) may be used.

$$\begin{matrix}[ Formula 65 ] & \\ z ( t , f ) = \frac{y ( t , f )}{{‖ y ( t , f ) ‖}_{2}} & ( 78 ) \\ [ Formula 66 ] & \\ {‖ y ( t , f ) ‖}_{2} = \sqrt{{\sum }_{m = 1}^{M} {\vert {y}_{m} ( t , f ) \vert}^{2}} & ( 79 )\end{matrix}$$

Also, feature amounts, such as phase differences and amplitude ratios between microphones and arrival time differences between or arrival directions of sound source signals, may be used as observation data.

Also, although the complex Gaussian mixture distribution is used as a mixture model to be applied to observation signal vectors, which are feature vectors, in the present first embodiment, various mixture models (e.g., a Gaussian mixture distribution, a Laplace mixture distribution, a complex Watson mixture distribution, a complex Bingham mixture distribution, a complex angular central Gaussian mixture distribution, a von Mises distribution, and the like) can be used depending on feature vectors used. Furthermore, not only a mixture model, but also a model of the complex Gaussian distribution and the like may be applied to observation signal vectors, which are feature vectors.

Also, although prior distributions of spatial covariance matrixes are modeled using the complex inverse Wishart mixture distribution in the present first embodiment, modeling may be performed using other models, such as the complex Wishart mixture distribution.

Also, although the present first embodiment adopts a method of maximizing the posterior probabilities of the parameters Θ to apply a model to observation data, a model may be applied to observation data using other methods.

Also, although optimization is performed using an auxiliary function method in the present first embodiment, optimization may be performed using other methods, such as a gradient method. In this case, the sound source existence posterior probability updating unit 12 and the sound source position posterior probability updating unit 14 are not indispensable.

### Second Modification Example of First Embodiment

A description is given of a second modification example of the first embodiment in which the true number N′ of sound sources is estimated and sound source separation is performed when the true number N′ of sound sources is unknown. In the present modification example, it is considered that the assumed number N of sound sources is set to be sufficiently large so as to be N≥N′. For example, when it is known that the assumed number of sound sources is 6 at most, it is sufficient to set the assumed number of sound sources to be N=6. Note that when the actual number of sound sources is 4, N′=4.

With respect to each n (where n is an integer equal to or larger than 1 and equal to or smaller than N), the estimation unit 10 uses a sound source position candidate corresponding to k that maximizes the sound source position prior probability βₖₙ from the sound source position prior probability updating unit 16 as an estimated value of a sound source position. Then, the signal analysis device 1 performs clustering of N sound source positions that have been obtained in the foregoing manner using, for example, hierarchical clustering, and uses the number of obtained clusters as an estimated value \hat{ }N′ of the actual number N′ of sound sources.

It is considered that the \hat{ }N′ clusters that have been obtained through clustering respectively correspond to the \hat{ }N′ actual sound sources. Therefore, this clustering makes clear to which one of the \hat{ }N′ actual sound sources each one of the N assumed sound sources n corresponds. In performing sound source separation, the estimation unit 10 performs subsequent processing as well, using this correspondence relationship.

The estimation unit 10 further calculates the sound source existence posterior probability λ′_{n′}(t,f) of the n′^{th} actual sound source by, with respect to each one of the obtained \hat{ }N′ clusters n′ (where n′ is a cluster index that is an integer equal to or larger than 1 and equal to or smaller than \hat{ }N′), adding one of the sound source existence posterior probabilities λₙ(t,f) of the N assumed sound sources that corresponds to this cluster. The estimation unit 10 further determines that, with respect to each time-frequency point (t,f), a signal from an actual sound source corresponding to the number n′ that maximizes the sound source existence posterior probability λ′_{n′}(t,f) of the actual sound source is producing sound at (t,f), similarly to expression (8). The estimation unit 10 further performs sound source separation by considering an estimated value \hat{ }x′_{n′}(t,f) of a sound source signal component of an actual sound source to be y(t,f) when it is determined that the n′^{th} actual sound source is producing sound at (t,f), and to be 0 when it is determined otherwise, similarly to expression (4).

### Third Modification Example of First Embodiment

The present first embodiment may be applied not only to sound signals, but also to other signals (electroencephalogram, magnetoencephalogram, wireless signals, and the like). Observation signals in the present first embodiment are not limited to observation signals obtained by a plurality of microphones (a microphone array), and may also be observation signals composed of signals that have been obtained by another sensor array (a plurality of sensors) of an electroencephalography device, a magnetoencephalography device, an antenna array, and the like, and that are generated from spatial positions in chronological order.

### Fourth Modification Example of First Embodiment

An example of modeling of probability distributions of observation signal vectors y(t,f) using a complex Gaussian distribution of the following expression (80) will be described as a fourth modification example of the first embodiment. In this case, the update rules of parameters Θ are as indicated by expression (81) to expression (86), instead of expressions (56), (57), (59), (60), (61), and (62) of the first embodiment.

$$\begin{matrix}[ Formula 67 ] & \\ p ( y ( t , f ) \vert Θ ) = {p}_{G} ( y ( t , f ) ; 0 , {\sum }_{n = 1}^{N} {υ}_{n} ( t , f ) {R}_{n} ( f ) ) & ( 80 )\end{matrix}$$

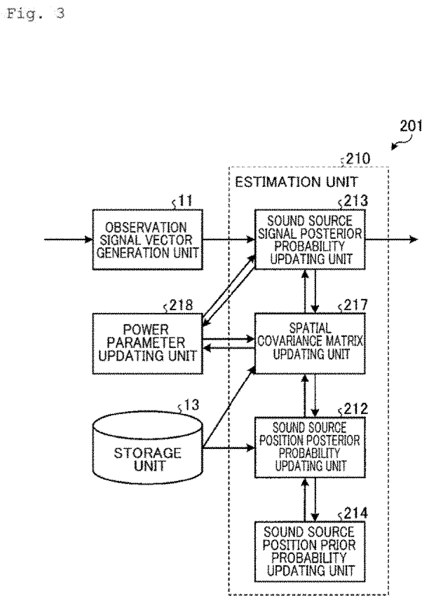

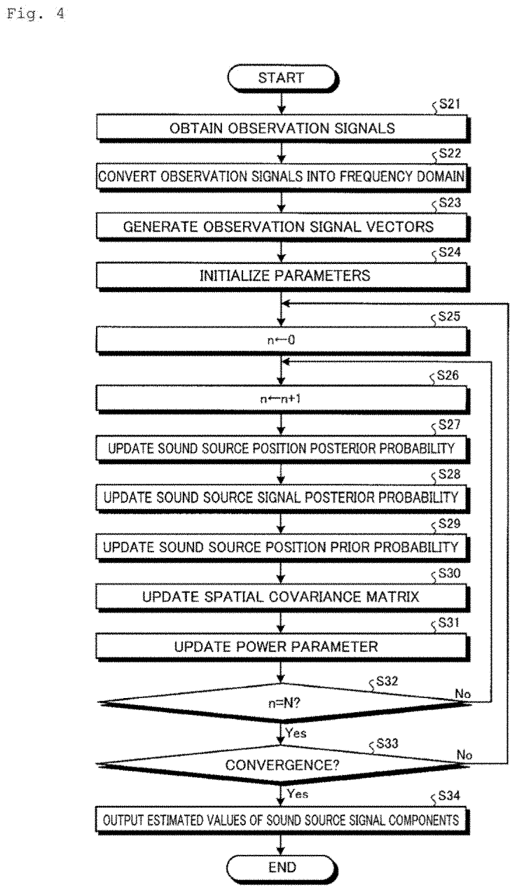

A configuration and processing of the fourth modification example of the first embodiment will be described using FIG. 3 and FIG. 4. FIG. 3 is a figure showing one example of a configuration of a signal analysis device according to the fourth modification example of the first embodiment. FIG. 4 is a flowchart showing one example of a processing procedure of signal analysis processing according to the fourth modification example of the first embodiment.

As shown in FIG. 3, a signal analysis device 201 according to the fourth modification example of the present first embodiment includes an observation signal vector generation unit 11, an initializing unit (not shown), a storage unit 13, an estimation unit 210, a power parameter updating unit 218, and a convergence determination unit (not shown). The estimation unit 210 includes a sound source position posterior probability updating unit 212, a sound source signal posterior probability updating unit 213, a sound source position prior probability updating unit 214, and a spatial covariance matrix updating unit 217.

Similarly to the first embodiment, the observation signal vector generation unit 11 generates observation signal vectors y(t,f) using expression (1) (step S21 to step S23).

The initializing unit calculates initial values of estimated values of a sound source position prior probability βₖₙ, a spatial covariance matrix Rₙ(f), and a power parameter vₙ(t,f) (step S24). Note that n=1, . . . , N denotes a sound source index, and k=1, . . . , K denotes a sound source position candidate index. For example, the initializing unit calculates these initial values based on random numbers. The initializing unit also initializes n (step S25).

Note that the storage unit 13 stores Ψₖ(f) and νₖ(f), which are parameters of prior distributions of spatial covariance matrixes for respective sound source position candidates k and respective frequency bins f.

Subsequently, the signal analysis device 201 adds 1 to n (step S26), and performs processes of step S27 to step S31.

The sound source position posterior probability updating unit 212 receives Ψₖ(f) and νₖ(f), which are the parameters of the prior distributions from the storage unit 13, a sound source position prior probability (note, as an exception, the initial value of the sound source position prior probability from the initializing unit at the time of first processing in the sound source position posterior probability updating unit 212) βₖₙ from the sound source position prior probability updating unit 214, and the spatial covariance matrix (note, as an exception, the initial value of the spatial covariance matrix from the initializing unit at the time of first processing in the sound source position posterior probability updating unit 212) Rₙ(f) from the spatial covariance matrix updating unit 217, and updates a sound source position posterior probability μₖₙ using expression (81) (step S27).

$$\begin{matrix}[ Formula 68 ] & \\ {μ}_{kn} ← \frac{{β}_{kn} {\prod }_{f = 1}^{F} ℐ𝒲 ( {R}_{n} ( f ) ; {Ψ}_{k} ( f ) , {v}_{k} ( f ) )}{{\sum }_{k = 1}^{K} {β}_{kn} {\prod }_{f = 1}^{F} ℐ𝒲 ( {R}_{n} ( f ) ; {Ψ}_{κ} ( f ) , {v}_{κ} ( f ) )} & ( 81 )\end{matrix}$$

The sound source signal posterior probability updating unit 213 receives the observation signal vectors y(t,f) from the observation signal vector generation unit 11, the power parameter (note, as an exception, the initial value of the power parameter from the initializing unit at the time of first processing in the sound source signal posterior probability updating unit 213) vₙ(t,f) from the power parameter updating unit 218, and the spatial covariance matrix (note, as an exception, the initial value of the spatial covariance matrix from the initializing unit at the time of first processing in the sound source signal posterior probability updating unit 213) Rₙ(f) from the spatial covariance matrix updating unit 217, and updates an average ξₙ(t,f) of posterior probabilities of a sound source signal component xₙ(t,f) and a covariance matrix Σₙ(t,f) using expression (82) and expression (83) (step S28).

$$\begin{matrix} [ Formula 69 ] & \\ {ξ}_{n} ( t , f ) ← {υ}_{n} ( t , f ) {R}_{n} ( f ) {( {\sum }_{v = 1}^{N} {υ}_{v} ( t , f ) {R}_{v} ( f ) )}^{- 1} y ( t , f ) & ( 82 ) \\ [ Formula 70 ] & \\ {Σ}_{n} ( t , f ) ← {υ}_{n} ( t , f ) {R}_{n} ( f ) {( {\sum }_{v = 1}^{N} {υ}_{v} ( t , f ) {R}_{v} ( f ) )}^{- 1} ( {\sum }_{i \neq n} {υ}_{v} ( t , f ) {R}_{v} ( f ) ) & ( 83 )\end{matrix}$$

The sound source position prior probability updating unit 214 receives the sound source position posterior probability μₖₙ from the sound source position posterior probability updating unit 212, and updates the sound source position prior probability βₖₙ using expression (84) (step S29).

[Formula 71]

βₖₙ←μₖₙ (84)

The spatial covariance matrix updating unit 217 receives Ψₖ(f) and νₖ(f), which are the parameters of the prior distributions from the storage unit 13, the sound source position posterior probability μₖₙ from the sound source position posterior probability updating unit 212, the average ξₙ(t,f) of the posterior probabilities and the covariance matrix Σₙ(t,f) from the sound source signal posterior probability updating unit 213, and the power parameter (note, as an exception, the initial value of the power parameter from the initializing unit at the time of first processing in the spatial covariance matrix updating unit 217) vₙ(t,f) from the power parameter updating unit 218, and updates the spatial covariance matrix Rₙ(f) using expression (85) (step S30).

$$\begin{matrix} [ Formula 72 ] & \\ {R}_{n} ( f ) ← \frac{{\sum }_{t = 1}^{T} \frac{1}{{υ}_{n} ( t , f )} ( {Σ}_{n} ( t , f ) + {ξ}_{n} ( t , f ) {{ξ}_{n} ( t , f )}^{H} ) + {\sum }_{k = 1}^{K} {μ}_{kn} {Ψ}_{k} ( f )}{T + {\sum }_{k = 1}^{K} {μ}_{kn} {v}_{k} ( f ) + M} & ( 85 )\end{matrix}$$

The power parameter updating unit 218 receives the spatial covariance matrix Rₙ(f) from the spatial covariance matrix updating unit 217 and the average ξₙ(t,f) of the posterior probabilities and the covariance matrix Σₙ(t,f) from the sound source signal posterior probability updating unit 213, and updates the power parameter vₙ(t,f) using expression (86) (step S31).

$$\begin{matrix}[ Formula 73 ] & \\ {υ}_{n} ( t , f ) ← \frac{1}{M} tr [ {{R}_{n} ( f )}^{- 1} ( {Σ}_{n} ( t , f ) + {ξ}_{n} ( t , f ) {{ξ}_{n} ( t , f )}^{H} ) \} & ( 86 )\end{matrix}$$

Then, the signal analysis device 201 determines whether n=N (step S32). If it is not determined that n=N (step S32: No), the signal analysis device 201 returns to step S26. On the other hand, if it is determined that n=N (step S32: Yes), the signal analysis device 201 proceeds to determination processing of the convergence determination unit.

The convergence determination unit determines whether convergence has been achieved (step S33). If the convergence determination unit determines that convergence has not been achieved (step S33: No), the signal analysis device 201 returns to step S25 and continues processing. On the other hand, if the convergence determination unit determines that convergence has been achieved (step S33: Yes), the sound source signal posterior probability updating unit 213 outputs averages ξₙ(t,f) of the posterior probabilities as estimated values \hat{ }xₙ(t,f) of sound source signal components xₙ(t,f) (step S34), and processing in the signal analysis device 201 ends.

### Fifth Modification Example of First Embodiment

Although the spatial characteristics of a sound source signal are modeled using a spatial covariance matrix in the first embodiment, the spatial characteristics of a sound source signal may be modeled using other parameters. A parameter for modeling the spatial characteristics of a sound source signal is referred to as a spatial parameter here.

For example, the spatial characteristics of a sound source signal may be modeled using a steering vector as a spatial parameter. In this case, the probability distribution of an observation signal vector y(t,f) can be modeled using, for example, a complex Gaussian distribution of the following expression (87).

$$\begin{matrix}[ Formula 74 ] & \\ p ( y ( t , f ) \vert Θ ) = {p}_{G} ( y ( t , f ) ; 0 , {\sum }_{n = 1}^{N} {υ}_{n} ( t , f ) {h}_{n} ( f ) {{h}_{n} ( f )}^{H} + {σ}_{1}^{2} I ) & ( 87 )\end{matrix}$$

Here, hₙ(f) denotes a steering vector which is a spatial parameter for modeling the spatial characteristics of a sound source signal n, and σ₁² is a positive number for regularization. In this case, the prior distribution of hₙ(f) is given by the following expression (88). Note that “p” in expression (88) denotes the complex Gaussian distribution “p_{G}”.

$$\begin{matrix} [ Formula 75 ] & \\ p ( {h}_{n} ( 1 ) , … , {h}_{n} ( F ) \vert {β}_{1 n} , … , {β}_{Kn} ) = {\sum }_{k = 1}^{K} {β}_{kn} {\prod }_{f = 1}^{F} p ( {h}_{n} ( f ) ; 0 , {g}_{k} ( f ) {{g}_{k} ( f )}^{H} + {σ}_{2}^{2} I ) & ( 88 )\end{matrix}$$

Here, gₖ(f) and σ₂² denote hyper parameters. gₖ(f) is a steering vector with respect to the k^{th} sound source position candidate, and σ₂² is a positive number for regularization. It is sufficient to estimate parameters Θ, similarly to the first embodiment, based on the foregoing modeling.

### [System Configuration, Etc.]

Also, the constituent elements of devices shown are functional concepts, and need not necessarily be physically configured as shown in the figures. That is to say, a specific form of separation and integration of devices is not limited to those shown in the figures, and all or a part of devices can be configured in a functionally or physically separated or integrated manner, in arbitrary units, in accordance with various types of loads, statuses of use, and the like. Furthermore, all or an arbitrary part of processing functions implemented in devices can be realized by a CPU and a program that is analyzed and executed by this CPU, or realized as hardware using a wired logic.

Also, among processes that have been described in the present embodiment, processes that have been described as being performed automatically can also be entirely or partially performed manually, or processes that have been described as being performed manually can also be entirely or partially performed automatically using a known method. In addition, processing procedures, control procedures, specific terms, and information including various types of data and parameters presented in the foregoing text and figures can be changed arbitrarily, unless specifically stated otherwise. That is to say, the processes that have been described in relation to the foregoing learning methods and speech recognition methods are not limited to being executed chronologically in the stated order, and may be executed in parallel or individually in accordance with the processing capacity of a device that executes the processes or as necessary.

### [Program]

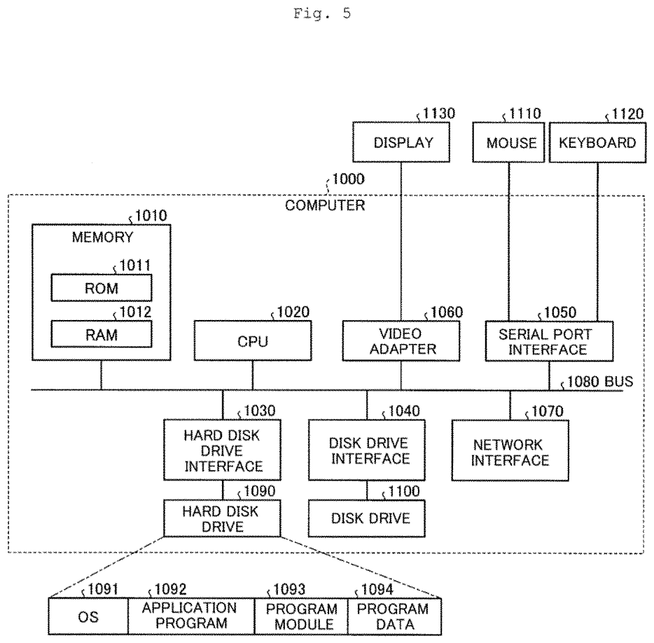

FIG. 5 is a figure showing one example of a computer with which the signal analysis devices 1, 201 are realized through the execution of a program. A computer 1000 includes, for example, a memory 1010 and a CPU 1020. The computer 1000 also includes a hard disk drive interface 1030, a disk drive interface 1040, a serial port interface 1050, a video adapter 1060, and a network interface 1070. These components are connected by a bus 1080.

The memory 1010 includes a ROM 1011 and a RAM 1012. The ROM 1011 stores, for example, a boot program such as a BIOS (Basic Input Output System). The hard disk drive interface 1030 is connected to a hard disk drive 1090. The disk drive interface 1040 is connected to a disk drive 1100. For example, a removable storage medium such as a magnetic disk and an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS (Operating System) 1091, an application program 1092, a program module 1093, and program data 1094. That is to say, a program that defines the processes of the signal analysis devices 1, 201 is implemented as the program module 1093 in which codes that can be executed by the computer 1000 are written. The program module 1093 is stored in, for example, the hard disk drive 1090. For example, the program module 1093 for executing processes that are similar to the functional configurations of the signal analysis devices 1, 201 is stored in the hard disk drive 1090. Note that the hard disk drive 1090 may be replaced with an SSD (Solid State Drive).

Also, setting data used in the processes of the above-described embodiment is stored as the program data 1094 in, for example, the memory 1010 and the hard disk drive 1090. Then, the CPU 1020 reads out the program module 1093 and the program data 1094 stored in the memory 1010 and the hard disk drive 1090 into the RAM 1012 and executes the same as necessary.

Note that the program module 1093 and the program data 1094 are not limited to being stored in the hard disk drive 1090, and may be, for example, stored in a removable storage medium and read out by the CPU 1020 via the disk drive 1100 and the like. Alternatively, the program module 1093 and the program data 1094 may be stored in another computer connected via a network (a LAN (Local Area Network), a WAN (Wide Area Network), and the like). Then, the program module 1093 and the program data 1094 may be read out from another computer by the CPU 1020 via the network interface 1070.

Although the above has explained the embodiment to which the invention made by the present inventors is applied, the present invention is not limited by a description and figures that compose a part of the disclosure of the present invention based on the present embodiment. That is to say, other embodiments, examples, operating techniques, and the like that are implemented by, for example, a person skilled in the art based on the present embodiment are all encompassed within the scope of the present invention.

### REFERENCE SIGNS LIST

1, 201, 1P Signal analysis device
10 Estimation unit
11, 11P Observation signal vector generation unit
12, 12P Sound source existence posterior probability updating unit
13, 13P Storage unit
14, 212 Sound source position posterior probability updating unit
14P Sound source existence prior probability updating unit Sound source existence prior probability updating unit
16, 214 Sound source position prior probability updating unit
17, 217, 15P Spatial covariance matrix updating unit
18, 218, 16P Power parameter updating unit
19, 17P Sound source signal component estimation unit
213 Sound source signal posterior probability updating unit

1. A signal analysis device, comprising:
estimation circuitry configured to, when a parameter for modeling spatial characteristics of signals from N signal sources (where N is an integer equal to or larger than 2) is a spatial parameter, estimate a signal source position prior probability which is a mixture weight for modeling a prior distribution of the spatial parameter with respect to each signal source using a mixture distribution that is a linear combination of prior distributions of the spatial parameter with respect to K signal source position candidates (where K is an integer equal to or larger than 2), and which is a probability that a signal arrives from each signal source position candidate per signal source.

2. The signal analysis device according to claim 1, wherein the spatial parameter is a spatial covariance matrix, and the mixture distribution is a complex inverse Wishart mixture distribution.

3. The signal analysis device according to claim 1, wherein the estimation circuitry estimates the signal source position prior probability based on an auxiliary function method using an auxiliary function which is related to an objective function for maximizing a posterior probability of an unknown parameter, and with which a sum operation in the linear combination included in the objective function is not included in a logarithm operation.

4. The signal analysis device according to claim 1, wherein provided that N is the number of signal sources that is assumed to be a number sufficiently larger than the actual number N′ of signal sources, the estimation circuitry uses a signal source position candidate that maximizes the signal source position prior probability as an estimated value of a signal source position with respect to each n (where n is an integer equal to or larger than 1 and equal to or smaller than N), performs clustering of obtained N signal source positions using hierarchical clustering, and uses the number of obtained clusters as an estimated value of the actual number N′ of sound sources.

5. A signal analysis method executed by a signal analysis device, the signal analysis method comprising: when a parameter for modeling spatial characteristics of signals from N signal sources (where N is an integer equal to or larger than 2) is a spatial parameter, estimating a signal source position prior probability which is a mixture weight for modeling a prior distribution of the spatial parameter with respect to each signal source using a mixture distribution that is a linear combination of prior distributions of the spatial parameter with respect to K signal source position candidates (where K is an integer equal to or larger than 2), and which is a probability that a signal arrives from each signal source position candidate per signal source.

6. A signal analysis program for causing a computer to function as the signal analysis device according to claim 1.
